(19) United States
(12) Patent Application Publication
(10) Pub. No.: US 2026/0213400 A1
(43) Pub. Date: Jul. 23, 2026

(54) VEHICULAR DEVICE, VEHICLE

(71) Applicants: YOKOWO CO., LTD., Tokyo (JP); TOYOTA JIDOSHA KABUSHIKI KAISHA, Toyota-shi (JP)

(72) Inventors: Atsushi UBUKATA, Tomioka-Shi (JP); Motonao TAKAHASHI, Tomioka-Shi (JP); Natsuki KOTERA, Kariya-shi (JP); Yukihisa NAKAGAWA, Toyota-shi (JP); Ayano YAMAMOTO, Toyota-shi (JP)

(73) Assignees: YOKOWO CO., LTD., Tokyo (JP); TOYOTA JIDOSHA KABUSHIKI KAISHA, Toyota-shi (JP)

(21) Appl. No.: 19/453,402

(22) Filed: Jan. 20, 2026

(30) Foreign Application Priority Data
Jan. 20, 2025 (JP) 2025-007777

(51) Int. Cl. H01Q 1/32; H01Q 1/38

(52) U.S. Cl. CPC H01Q 1/3275; H01Q 1/38

(57) ABSTRACT

A vehicular device includes: a base that is electrically conductive, the base including a main body portion that is to be located on a first surface side of a first member that is electrically conductive, and a protruding portion that is to be inserted into an attachment hole formed in the first member; a second member that is to be located on a second surface side opposite to the first surface of the first member and that has a hole through which the protruding portion is to be inserted; an insulating member located between the second surface and the second member; and an attachment portion for attaching the base to the first member, wherein the base and the first member are insulated from each other.

### CROSS-REFERENCE TO RELATED APPLICATIONS

The present application claims priority pursuant to 35 U.S.C. §119 from Japanese patent application number 2025-007777 filed on January 20, 2025, the entire disclosure of which is hereby incorporated by reference herein.

### BACKGROUND

### Technical Field

The present disclosure is related to a vehicular device and a vehicle.

### Description of the Related Art

Japanese Patent Application Publication No. 2018-184022 discloses an antenna device that is to be attached to the roof of a vehicle.

When the roof attached with an antenna device is made of a conductive material, the roof and the antenna device may be electrically connected. In such a case, for example, electrolytic corrosion may occur between the roof and the metallic support member that supports the roof.

### SUMMARY

An aspect of the present disclosure is a vehicular device, comprising: a base that is electrically conductive, the base including a main body portion that is to be located on a first surface side of a first member that is electrically conductive, and a protruding portion that is to be inserted into an attachment hole formed in the first member; a second member that is to be located on a second surface side opposite to the first surface of the first member and that has a hole through which the protruding portion is to be inserted; an insulating member located between the second surface and the second member; and an attachment portion for attaching the base to the first member, wherein the base and the first member are insulated from each other.

Another aspect of the present disclosure is a vehicular device, comprising: a base that is electrically conductive, the base including a main body portion that is to be located on a first surface side of a first member made of a carbon-based material, and a protruding portion that is to be inserted into an attachment hole formed in the first member; a second member that is to be located on a second surface side opposite to the first surface of the first member and that has a hole through which the protruding portion is to be inserted; an insulating member located between the second surface and the second member; and an attachment portion for attaching the base to the first member.

### BRIEF DESCRIPTION OF THE DRAWINGS

FIG. 1 is a diagram to describe the main configuration of a vehicle C.

FIG. 2 is an exploded perspective view of an antenna device 10.

FIG. 3 is a diagram illustrating an antenna device 10 in cross section taken along line A-A of FIG. 2.

FIG. 4 is a diagram illustrating an antenna device 10 in cross section taken along line A-A of FIG. 2.

### DETAILED DESCRIPTION

At least the following matters will become apparent from the description of the present specification and the accompanying drawings.

With reference to the drawings, preferred embodiments of the present disclosure will be described below. The same or equivalent components, members, and the like illustrated in the drawings are denoted by the same reference numerals, and redundant description thereof is omitted as appropriate.

### Overview of antenna device 10

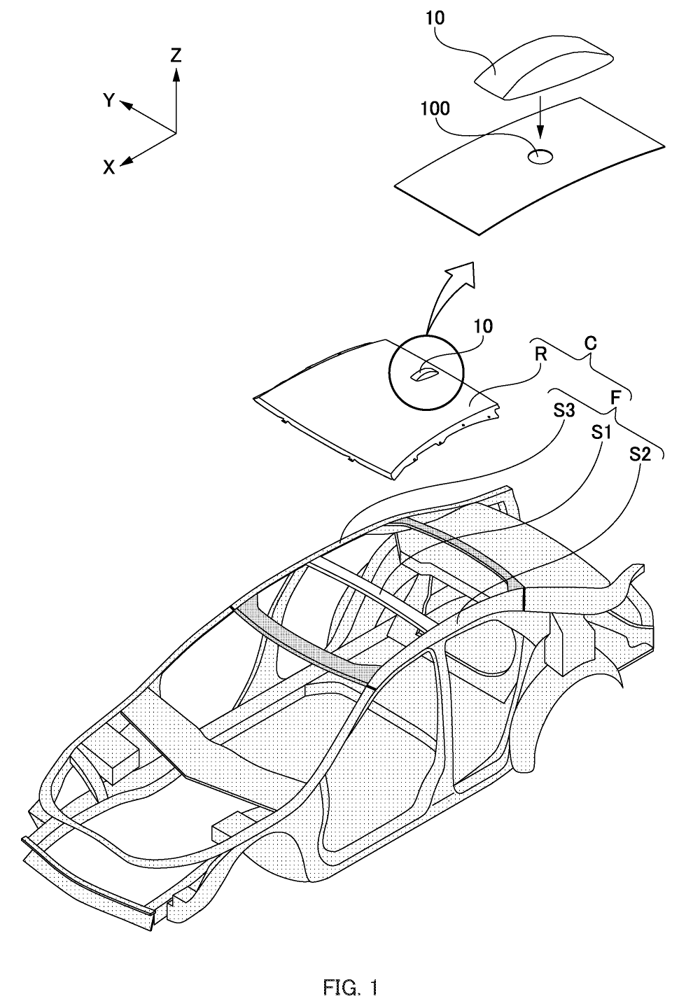

FIG. 1 is a diagram illustrating the relationship between a frame F and a roof R, which are the main components of a vehicle C. First, the directions and the like in an embodiment of the present disclosure will be defined with reference to FIG. 1. In FIG. 1, a part of the structure of an antenna device 10 is omitted, for convenience.

### Definition of directions and the like

In the following description, a front-rear direction of the vehicle at which the vehicular antenna device 10 is attached is defined as an X direction, a left-right direction perpendicular to the X direction is defined as a Y direction, and a vertical direction perpendicular to the X and Y directions is defined as a Z direction. As seen from the driver’s seat of the vehicle, the front side is a +X direction, the right side is a +Y direction, and the zenith direction (upward direction) is a +Z direction. The up-down direction may be referred to as vertical direction.

The +X direction, -X direction, +Y direction, -Y direction, +Z direction, and -Z direction are directions with fixed orientations. The above-described directions may not be fixed directions, but both the +X direction and the −X direction may be simply referred to as “X direction”. Similarly, both the +Y direction and the −Y direction may be simply referred to as “Y direction”. In addition, both the +Z direction and the −Z direction may be simply referred to as “Z direction.”.

In FIG. 1, respective directions of the +X, +Y, and +Z directions are indicated by arrowed line segments for easier understanding of the directions and the like of the antenna device 10. The point of intersection of these arrowed line segments does not mean the coordinate origin. The definitions of the directions and the like described above are common in the present specification, unless otherwise specified.

### Overview of vehicle C

The vehicle C includes the frame F and the roof R as the main components. The frame F is a member made of aluminum, for example. The frame F includes a reinforcing member S1 in the ceiling portion of the vehicle C and the roof side rails S2 and S3. It is assumed that the frame F in an embodiment of the present disclosure is made of aluminum, but it is not limited thereto and may be made of other conductive members such as iron and the like.

The roof R is a panel of carbon-based material and is attached to the frame F so as to form the ceiling of the vehicle. In an embodiment of the present disclosure, the roof R is fixed to the roof side rails S2 and S3 while being supported by the reinforcement member S1. Hereinafter, the surface on the +Z side of the roof R may be referred to as "front surface", and the surface on the -Z side of the roof R may be referred to as "back surface".

Of the front surface and the back surface of the roof R in an embodiment of the present disclosure, the front surface is applied with an insulating coating, for example. Further, the roof R in an embodiment of the present disclosure is made of carbon of a carbon-based material, but it is not limited thereto and may be made of a conductive material. In addition, in the roof R, an attachment hole 100 for attaching the antenna device 10 (described later).

### Antenna device 10

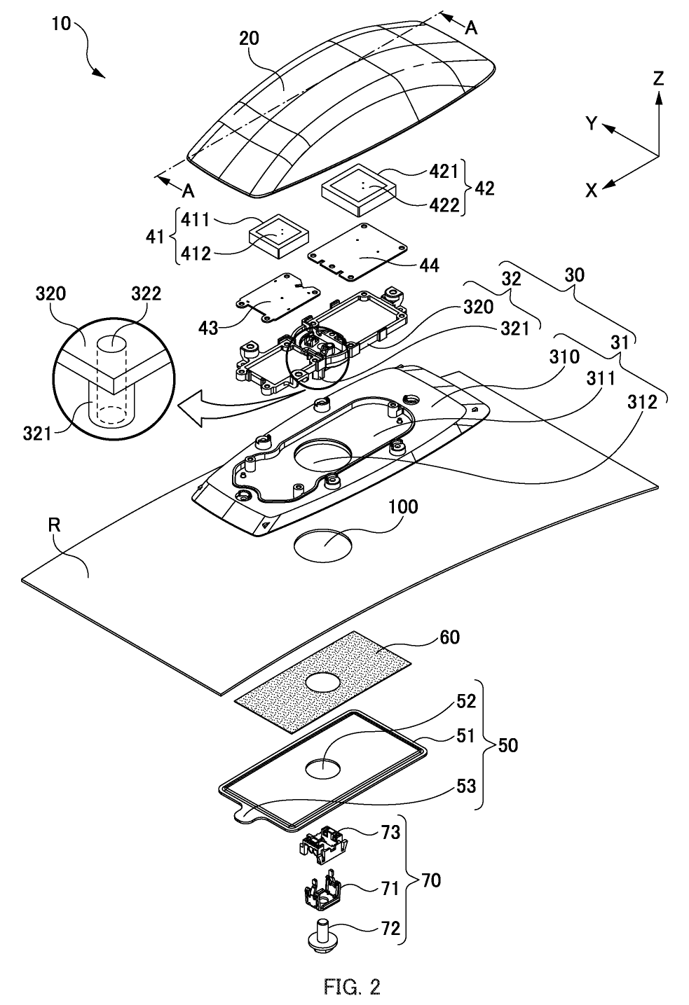

The antenna device 10 is a device that is to be attached to the roof R of the vehicle C, and as illustrated in FIG. 2, includes a case 20, an antenna base 30, patch antennas 41, 42, substrates 43, 44, an attachment plate 50, an insulating tape 60, and an attachment portion 70. The antenna device 10 corresponds to a "vehicular device" to be used for the vehicle C.

The case 20 is a member (so-called a radome) that covers the antenna base 30 (described below) from above, to thereby form, together with the antenna base 30, an accommodation space in which the patch antennas 41, 42, and the like are to be accommodated. The case 20 is made of synthetic resin (for example, ABS resin) that is electromagnetically transparent. The case 20 and the antenna base 30 are fixed using a plurality of screws (not illustrated), for example.

The antenna base 30 is a member that constitutes the bottom face of the antenna device 10 and is arranged at the front surface of the roof R. The roof R of an embodiment of the present disclosure corresponds to a "first member", the front surface of the roof R corresponds to a "first surface", and the back surface on the side opposite to the front surface corresponds to a "second surface".

The antenna base 30 includes, for example, the insulating base 31 made of resin, and a conductive base 32 made of metal.

The insulating base 31 is a member that is to be attached to the conductive base 32 (described later) so as to surround the outer periphery of the conductive base 32. The insulating base 31 includes a main body portion 310, a recess 311 formed in the main body portion 310 in which the conductive base 32 is to be fitted, and a hole 312 into which a protruding portion 321 (described later) of the conductive base 32 is to be inserted.

The conductive base 32 is a member configured to function as a ground of the antenna device 10. A part of the conductive base 32 is used to attach the antenna device 10 to the roof R, and includes a main body portion 320 and the protruding portion 321, which is a protruding shape, formed to extend downward at a position near the center of the main body portion 320. The protruding portion 321 has formed therein a hole 322 into which a bolt 72 (described below) made of metal is to be inserted. The conductive base 32 is a die-cast product made of aluminum alloy, for example. In the drawings of an embodiment of the present disclosure, for easy understanding of the structures of the protruding portion 321, and the like, structures have been illustrated while being appropriately simplified.

In an embodiment of the present disclosure, water is prevented from entering the interior of the vehicle by sandwiching a sealing member (not illustrated) between the insulating base 31 and the roof R, when the antenna device 10 is attached to the roof R.

Further, when the antenna device 10 is attached to the roof R, the protruding portion 321 of the conductive base 32 is inserted into the hole 312 and the attachment hole 100 of the roof R. As a result, the end part on the -Z side of the protruding portion 321 of the conductive base 32 is positioned below the back surface (the surface on the -Z side) of the roof R.

The patch antenna 41 is a planar antenna that operates with the radio waves in the 2.3 GHz band for the Satellite Digital Audio Radio Service (SDARS), for example. The patch antenna 41 includes a dielectric 411 made of a dielectric material such as ceramic, and a radiating element 412 that operates with the radio waves in the 2.3 GHz band.

The patch antenna 42 is, for example, an antenna to receive the radio waves in the L1 band (the center frequency: 1575.42 MHz) for the Global Navigation Satellite System (GNSS). The patch antenna 42 includes a dielectric 421 made of a dielectric material such as ceramic and the like, and a radiating element 422 that operates with the radio waves in the L1 band. The communication standard and frequency band with which each of the patch antennas 23, 24 operates are not limited to those described above, and it may operate with other communication standards and frequency bands.

The substrate 43 is a circuit board where the patch antenna 41 is mounted, and is arranged on the front surface side of the conductive base 32. Similarly to the substrate 43, the substrate 44 is also a circuit board where the patch antenna 42 is mounted, and is arranged on the front surface side of the conductive base 32.

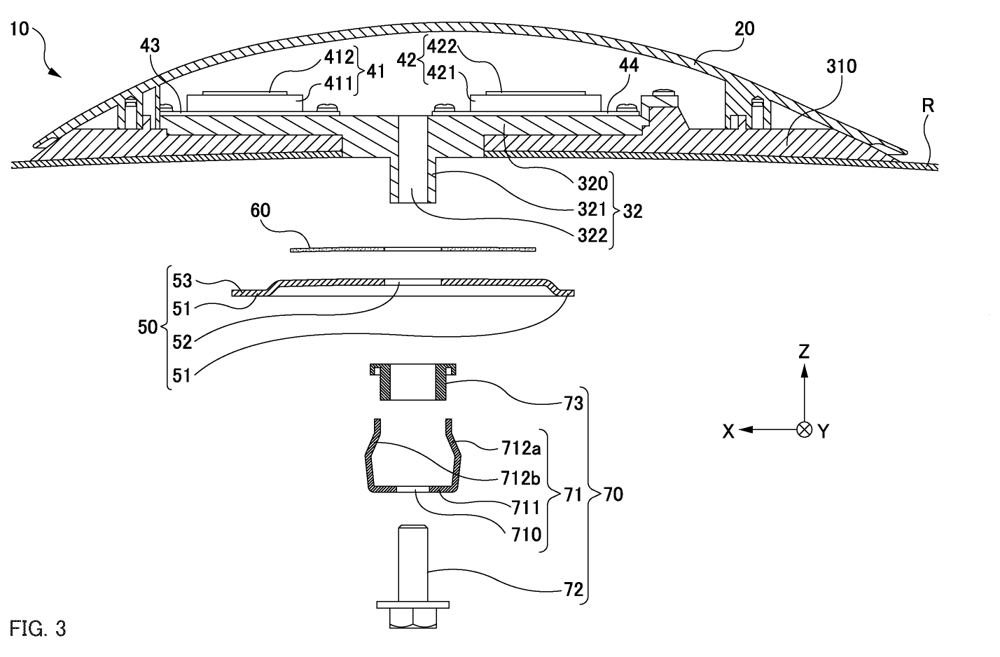

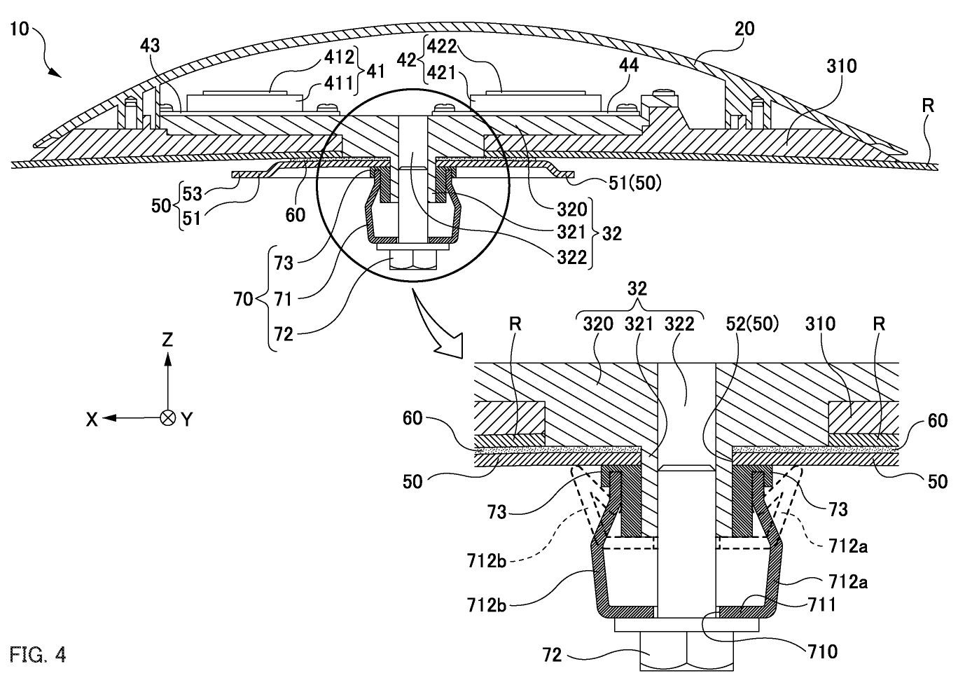

In an embodiment of the present disclosure, the case 20 that accommodates the patch antennas 41, 42, and the like, and the antenna base 30 are arranged at the roof R. The arrangement at the roof R is performed such that the protruding portion 321 of the conductive base 32 is inserted into the attachment hole 100, as illustrated in FIG. 3. The following describes the details of the antenna device 10 with reference to FIGS. 3 and 4 as appropriate. FIGS. 3 and 4 are illustrated with the components of the antenna device 10 (for example, the conductive base 32, etc.) being simplified as appropriate, for easy understanding of the structure of the antenna device 10.

The attachment plate 50 is located on the back surface side of the roof R and is a metallic plate-shaped member for attaching the antenna device 10 to the roof R together with the attachment portion 70 (described below). As will be described in detail below, when the antenna device 10 is attached to the roof R, a part of a washer 71 (described below), made of metal, of the attachment portion 70 is pressed against the attachment plate 50.

Near the center of the attachment plate 50, a hole 52 is formed, through which the protruding portion 321 of the conductive base 32 is to be inserted. An outer peripheral edge portion 51 of the attachment plate 50 is bent in the −Z direction (downward). A protrusion part 53 is formed at the end of the attachment plate 50 in the +X direction so that a worker can hold the attachment plate 50.

The insulating tape 60 is a member for temporarily fixing the attachment plate 50 to the back surface of the roof R and electrically insulating the attachment plate 50, made of metal, from the roof R, made of carbon. In an embodiment of the present disclosure, the insulating tape 60 is attached to a region of the front surface (the surface in the +Z direction) of the attachment plate 50 except the hole 52.

The attachment portion 70 is a general term for the parts for fixing the conductive base 32 to the roof R from the −Z direction side, and includes the washer 71, the bolt 72, and a holder 73.

The washer 71 is a metallic part to be attached to the protruding portion 321 of the conductive base 32. The washer 71 of an embodiment of the present disclosure includes a flat portion 711 with a hole 710, and legs 712a, 712b extending from the flat portion 711 in the +Z direction. The legs 712a, 712b of the washer 71 are housed in the grooves of the holder 73, respectively. Then, after the holder 73 and the washer 71 are temporarily fixed to the back surface of the attachment plate 50, the bolt 72 is inserted into the hole 710 of the washer 71 from the −Z direction.

The bolt 72 is a part to secure the attachment plate 50 to the roof R, and the holder 73 is a part made of resin to temporarily fix the conductive base 32 to the roof R and holds the washer 71.

The bolt 72 that is inserted into the hole 710 is inserted also into the hole 322 of the conductive base 32, which corresponds to the screw hole of the protruding portion 321, and is screwed thereto. As a result, as illustrated in the enlarged view of FIG. 4, the legs 712a, 712b of the washer 71 are bent while being opened outward (here, in the X direction, for example).

Then, the legs 712a, 712b of the washer 71 are deformed into the shapes given by the dashed lines in the enlarged view in FIG. 4, to thereby press the back surface of the attachment plate 50 in the +Z direction. As a result, in an embodiment of the present disclosure, the conductive base 32 and the attachment plate 50 are fixed in such a manner as to sandwich the roof R therebetween, resulting in the antenna device 10 being attached to the roof R.

Here, in the vehicle C, the roof R made of carbon is supported by the frame F that includes the aluminum reinforcing member S1 and the roof side rails S2, S3. Both the roof R and the frame F are conductive members, and thus if the roof R becomes charged, electrolytic corrosion may occur between the roof R and the frame F. In an embodiment of the present disclosure, the roof R and the washer 71 that may become charged are insulated from each other, for example, by the insulating tape 60, in the back surface of the roof R. Accordingly, even if the antenna device 10 is attached to the roof R, it is suppressed that the roof R becomes charged, thereby preventing electrolytic corrosion between the roof R and the frame F.

In an embodiment of the present disclosure, the outer peripheral edge portion 51 of the attachment plate 50 is bent downward. Thus, when the front surface of the attachment plate 50 is pressed against the back surface of the roof R, the outer peripheral edge portion 51 of the attachment plate 50 and the roof R are separated from each other. Accordingly, even if there are metal burrs at the outer periphery of the attachment plate 50, it is possible to prevent the metal burrs from coming into contact with the back surface of the roof R.

### Modification example(s)

In an embodiment of the present disclosure, the attachment plate 50 made of metal, but it is not limited thereto. For example, as the attachment plate 50, the plate-shaped member made of insulating resin may be used. Even in such a case, it is possible to exert effect as in an embodiment of the present disclosure. When the attachment plate 50 made of an insulating material is used, for example, the washer 71 of the antenna device 10 and the roof R can be insulated from each other, for example, without using the insulating tape 60.

Further, it is assumed in an embodiment of the present disclosure that the insulating tape 60 is used between the roof R and the attachment plate 50, made of metal, however, those other than the insulating tape 60 may be used as long as the roof R and the metal attachment plate 50 can be insulated from each other. In specific, instead of the insulating tape 60, an insulating adhesive, an insulating sheet, an insulating resin material, rubber, or the like may be used.

In an embodiment of the present disclosure, an example in which the antenna device 10 is attached to the roof R has been described, however, an electronic device other than the antenna device 10 may be attached to the roof R. Examples of such electronic devices include, but are not limited to, a radar device, a camera device, a light emitting device, and the like. In such a case, the electronic device and the roof R can be insulated from each other, thereby being able to prevent the occurrence of electrolytic corrosion between the roof R and the reinforcing member S1.

### Summary

According to the present specification, a vehicular device of Aspects described below is provided.

### Aspect 1

Aspect 1 is a vehicular device comprising: a base that is electrically conductive, and includes a main body portion that is to be located on the first surface side of a first member that is electrically conductive, and a protruding portion that is to be inserted into an attachment hole formed in the first member; a second member that is to be located on the second surface side opposite to the first surface of the first member and that has a hole through which the protruding portion is to be inserted; an insulating member located between the second surface and the second member; and an attachment portion for attaching the base to the first member, wherein the base and the first member are insulated from each other.

The roof R corresponds to the "first member that is electrically conductive", the conductive base 32 corresponds to the "base that is electrically conductive", the attachment plate 50 corresponds to the "second member", and the insulating tape 60 corresponds to the "insulating member". The antenna device 10 corresponds to the "vehicular device".

According to Aspect described above, it is possible to prevent electrolytic corrosion between the roof R made of carbon and the frame F made of aluminum, for example, when the antenna device 10 is attached to the vehicle C.

### Aspect 2

Aspect 2 is a vehicular device comprising a base that is electrically conductive, the base including a main body portion that is to be located on a first surface side of a first member made of a carbon-based material and a protruding portion that is to be inserted into an attachment hole formed in the first member, a second member that is to be located on the second surface side opposite to the first surface of the first member and that has a hole through which the protruding portion is to be inserted, an insulating member located between the second surface and the second member, and an attachment portion for attaching the base to the first member.

The roof R corresponds to the "first member made of a carbon-based material", the conductive base 32 corresponds to the "base that is electrically conductive", the attachment plate 50 corresponds to the "second member", and the insulating tape 60 corresponds to the "insulating member". The antenna device 10 corresponds to the "vehicular device".

According to Aspect described above, it is possible to prevent electrolytic corrosion between the roof R made of carbon and the frame F made of aluminum, for example, when the antenna device 10 has been attached to the vehicle C.

### Aspect 3

In Aspect 3, the outer peripheral edge portion of the second member is bent in a direction opposite to the first member.

According to Aspect above described, it is possible to appropriately protect the roof R from metal burrs and the like at the outer peripheral edge portion 51 of the attachment plate 50.

### Aspect 4

In Aspect 4, the first member is a roof of a vehicle.

According to Aspect described above, for example, it is possible to attach the antenna device 10 to the roof R of the vehicle C.

### Aspect 5

In Aspect 5, the second member is electrically conductive.

According to Aspect described above, it is possible to use a conductive plate-shaped member made of metal such as iron and the like, as the attachment plate 50, for example. Thus, as compared to the case where a plate made of resin is used as the attachment plate 50, for example, the attachment portion 70 can be fixed to the back surface of the roof R with a stronger force.

### Aspect 6

In Aspect 6, the second member is insulating.

According to Aspect described above, for example, a plate-shaped member made of insulating resin can be used as the attachment plate 50. In such a case, for example, the antenna device 10 can be attached to the roof R without using the insulating tape 60. Further, for example, a surface of the attachment plate 50 made of metal may be coated with an insulating material. In such a case, the antenna device 10 can be attached to the roof R without using the insulating tape 60.

### Aspect 7

Aspect 7 is a vehicle comprising the vehicular device of Aspect 1 or Aspect 2 and the first member.

According to Aspect described above, it is possible to suppress the occurrence of electrolytic corrosion in the vehicle C when the antenna device 10 is attached to the vehicle C.

According to an aspect described above of the present disclosure, provided is a vehicular device capable of preventing electrolytic corrosion when attached to a vehicle.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A vehicular device, comprising:
a base that is electrically conductive, the base including
a main body portion that is to be located on a first surface side of a first member that is electrically conductive, and
a protruding portion that is to be inserted into an attachment hole formed in the first member; a second member that is to be located on a second surface side opposite to the first surface of the first member and that has a hole through which the protruding portion is to be inserted;
an insulating member located between the second surface and the second member; and
an attachment portion for attaching the base to the first member, wherein
the base and the first member are insulated from each other.

2. A vehicular device, comprising:
a base that is electrically conductive, the base including
a main body portion that is to be located on a first surface side of a first member made of a carbon-based material, and
a protruding portion that is to be inserted into an attachment hold formed in the first member; a second member that is to be located on a second surface side opposite to the first surface of the first member and that has a hole through which the protruding portion is to be inserted;
an insulating member located between the second surface and the second member; and
an attachment portion for attaching the base to the first member.

3. The vehicular device according to claim 1, wherein an outer peripheral edge portion of the second member is bent in a direction opposite to the first member.

4. The vehicular device according to claim 1, wherein the first member is a roof of a vehicle.

5. The vehicular device according to claim 1, wherein the second member is electrically conductive.

6. The vehicular device according to claim 1, wherein the second member is insulating.

7. A vehicle, comprising:
the vehicular device according to claim 1; and the first member.

8. The vehicular device according to claim 2, wherein an outer peripheral edge portion of the second member is bent in a direction opposite to the first member.

9. The vehicular device according to claim 2, wherein the first member is a roof of a vehicle.

10. The vehicular device according to claim 2, wherein the second member is electrically conductive.

11. The vehicular device according to claim 2, wherein the second member is insulating.

12. A vehicle, comprising:
the vehicular device according to claim 2; and the first member.
